(19) United States
(12) Patent Application Publication
(10) Pub. No.: US 2021/0142431 A1
(43) Pub. Date: May 13, 2021

(54) METHOD AND SYSTEM FOR DATA ANALYSIS AND SUPPORT OF TRANSACTIONS IN THE GLOBAL REAL ESTATE MARKET

(71) Applicant: NovaSoftware OU, Tallinn (EE)

(72) Inventor: Denis Anatolievich RADZIMOVSKII, Saint-Petersburg (RU)

(21) Appl. No.: 16/678,684

(22) Filed: Nov. 8, 2019

(51) Int. Cl. G06Q 50/16; G06Q 20/40; G06Q 20/38; G06Q 40/02

(52) U.S. Cl. CPC G06Q 50/165; G06Q 40/02; G06Q 20/3825; G06Q 20/4014

(57) ABSTRACT

The present disclosure, in general, relates to the field of computer technology, and, in particular, to methods and systems based on cloud technologies, machine learning and distributed ledger technologies to support real estate transactions. It is a method of real estate transaction support, performed by means of at least one processor, wherein the data about at least one user who buys or invests in a real estate unit and/or a land plot and the data about at least one user who sells or raises funds for at least one real estate unit and/or one land plot, as well as the data about them, are obtained; at least one financial model is developed, which represents a description of at least one real estate unit and/or one land plot and its development, in monetary terms, based on data about it previously obtained for the user who buys or invests in a real estate unit and/or a land plot. At least one session of parties to a transaction is created via the messenger, which joins at least one user who has selected at least one specific real estate unit and/or a land plot and at least one user who is the owner of at least one selected real estate unit and/or one land plot. This leads to the formation of at least one BTS (Business Term Sheet) in the messenger and concludes with at least one transaction contract in terminal; a smart-contract is concluded automatically based on the BTS and transaction agreement. If the terms of the smart-contract are accepted, the monetary funds from at least one user who buys or invests in at least one real estate unit and/or land plot are transferred to at least one other user who sells or raises funds for at least one real estate unit and/or land plot.

### FIELD OF THE INVENTION

The present disclosure, in general, relates to the field of computer technology, and, in particular, to methods and systems based on cloud technologies, machine learning and distributed ledger technologies to support real estate transactions.

### BACKGROUND OF THE INVENTION

Currently, the total amount of investments in the real estate market, expressed in monetary terms, is calculated as the sum of all registered transactions occurring in the market. According to the data of the Cushman & Wakefield international company, global real estate investment in 2018 amounted to $1.8 trillion, and the annual increase in registered transactions in the global real estate market until 2030 in absolute values will vary in the range of 1-1.2%.

Today, in the era of the fourth technological revolution, all segments of the economy are transforming and switching to a new “digital” format. The same is true of the global real estate market, in which, under the influence of demand for innovation, the influence of Property Technology (abbr. PropTech) is growing. New technologically innovative products created for the real estate market allow for automating the processes of construction and real estate administration, minimizing the costs associated with real estate services, simplifying investment processes, etc. Without such products offering the enhancement of operating efficiency through automation, the real estate market will simply not be able to function under new and constantly changing market conditions

At the moment, in the prior art there is no unified, reliable and relevant service to support real estate transactions. This does not allow for making high-quality management decisions, which leads to an irrational use of territories and resources, as well as an uneven distribution of investment flows.

Also, one may note the lack of conditions and opportunities for safe and effective interaction between participants. Market participants regularly deal with imperfections in relevant legal and economic arrangements that should instead ensure effective and reliable interaction between them.

The prior art discloses the patent application AU2019100421A4 “New system and method of conducting real estate sales transactions online” (applicants: Ansari Morteza Seraj Mr Nasseri Taraneh Mrs, pubd: May 23, 2019). This application discloses a system and method for conducting real estate sales transactions online using blockchain technology; this is done by recording real estate sales transactions in the blockchain, enabling peer-to-peer conveyance of property, and completing the settlement process in the blockchain. Relevant government institutions and property registers, as well as the central board, have access to the private shared ledger.

The disadvantage of the present disclosure is that a private blockchain has weaknesses associated with the likely occurrence of affiliation of all node holders. An additional disadvantage is that the legitimization of one's own real estate registry, even in the territory of one state, is a very difficult job with many risks.

It is also known as the US patent application US20190073729A1 “Blockchain-Powered Real Estate Sales and Rental System”(applicant: Shelterzoom, pubd: Mar. 7, 2019). This application discloses a system of transactions, which includes Internet-connected partner platforms available in companies engaged in real estate sales, which display real estate properties held for sale or lease using the “Offer Now” button, initiating the encoded instructions to display an electronic input form that allows users to configure an offer by one of the properties. When a person, activating the “Offer Now” button from a mobile device, sends a confirmation code to the device, this confirmation code should be sent back to verify the device, and when this person types in the offers provided via the device, this electronic form is tracked to be saved as an offer for the sale or lease of a specific property. In fact, this is an aggregator of offers for the purchase/sale of real estate with a deal-making feature through the blockchain. This solution does not solve any problems in the prior art, except for the search for real estate purchase/sale offers; moreover, the described work with the blockchain is out of touch with state registers, which in itself is not an operative structure.

### SUMMARY OF THE INVENTION

The technical problem or the technical task of the present disclosure is the implementation of a method and a system providing for the collection, aggregation and systematization of data, the nature of which concerns the global real estate market, in addition to predictive analysis using algorithms of machine learning. The task and the final result of the present disclosure are the theoretically predicted investment and other characteristics of a given real estate unit or a certain territory.

The technical result achieved in solving the above technical problem is to increase the efficiency of primary investigation of real estate units, as well as improving the security and speed of relationships between professional participants in the real estate market.

Moreover, the accuracy of forecasting financial indicators in projects with real estate units or land plots is increased, given that more accurate figures are used, which means that the probability of error at later stages of the project is reduced, along with a reduction of critical errors leading to technological disasters.

Also, an increase in the security and speed of user relationships is achieved, as the present disclosure creates conditions that minimize the likelihood of unfair and malicious activity of participants, and also speeds up their work by reducing the number of intermediaries and speeding up operational processes.

The specified technical result is achieved due to the implementation of a unique method of data analysis and support of transactions in the global real estate market, performed by means of at least one processor, in which the data of at least one user who buys or invests in a property and/or land plot and the data of at least one user who sells or raises funds for at least one real estate unit and/or one land plot are obtained, as well as data about them are obtained. At least one financial model is then developed that represents the description of at least one real estate unit and/or one land plot and its development in monetary terms based on previously obtained data about it for the user who buys or invests in a real estate unit and/or a land plot; at least one session between the parties to the transaction is then arranged through the messenger, which joins at least one user who has selected at least one specific real estate unit and/or land plot with at least one user who is the owner of at least one selected real estate unit and/or land plot, and at least one BTS (Business Term Sheet) is formed in the messenger. A transaction contract is formed, and on the basis of the BTS and the transaction contract, a smart-contract is concluded according to transaction instructions received from the users; if the terms of the smart-contract are accepted, money is transferred from at least one user who buys or invests in at least one real estate unit and/or land plot, to at least one other user who sells or invests in at least one real estate unit and/or land plot.

In some embodiments of the present disclosure after obtaining data about the user, his/her identification and verification is carried out.

In some embodiments of the present disclosure, data about the real estate unit and/or land plot in the form of layers from open data sources in the form of unstructured data is obtained.

In some embodiments of the present disclosure, verification includes authentication of identity, residency, and payment details using a group of procedures that comply with KYC and AML policies.

In some embodiments of the present disclosure, after filling out the contract, each of the parties signs it with an electronic digital signature.

In some embodiments of the present disclosure, a transaction contract is formed from a set of predefined blocks in one or more languages.

In some embodiments of the present disclosure, the financial model includes the calculation of financial indicators, such as payback period and/or calculation of the necessary investments, and/or NPV, and/or IRR, and/or ROI, and/or Implementation period.

In some embodiments of the present disclosure, the terms of the smart-contract are accepted in a decentralized distributed blockchain register.

In some embodiments of the present disclosure, after receiving data about the real estate unit and/or the land plot, the data are verified.

In some embodiments of the present disclosure, the messenger is implemented as a service application that users need to discuss the conditions of a future transaction prior to initiating it.

### BRIEF DESCRIPTION OF THE DRAWINGS

The features and advantages of the present disclosure will be evident from the following detailed description and attached drawings where:

FIG. 1 depicts an example of the implementation of processes of development, testing, quality control and delivery through which the present disclosure is implemented.

FIG. 2 depicts an example of the implementation of a container on which the components of the present disclosure are implemented.

FIG. 3 depicts an example of the implementation of the graphical user interface of the system, which displays filters where the user can select a specific real estate unit or land plot.

FIG. 4 depicts an example of the implementation of the system of data analysis and support of transactions in the global real estate market.

FIG. 5 depicts graphs displaying the Internal Rate of Return|IRR and NCF Sensitivity Model.

FIG. 6 depicts an example of the implementation of the digital signature architecture.

FIG. 7 depicts an example of the implementation of the method of data analysis and support of transactions in the global real estate market in the form of a flow chart.

FIG. 8 depicts an example of the implementation of the architecture of the system of data analysis and support of transactions in the global real estate market.

### DETAILED DESCRIPTION OF THE PREFERRED EMBODIMENTS

The terms and their definitions used in the description of the present disclosure will be considered in detail below.

In this invention, a system means a computer system, an electronic computing machine (ECM), numeric control (NC), a programmable logic controller (PLC), computer-assisted command systems, and any other devices capable of executing a specified, clearly determined sequence of operations (actions, commands), centralized and distributed databases, smart-contracts.

A command-processing device means an electronic unit or an integrated circuit (microprocessor) that executes machine commands (programs), and a smart-contract, and an Ethereum virtual machine (EVM), etc. The command-processing device reads and executes computer-based commands (programs) from one or more data storage devices. Data storage devices may include hard disk drives (HDD), flash memory, read-only memory (ROM), solid-state drives (SSD), optical disc drives (ODD), etc.

A program is a sequence of commands to be executed by a computer control device or a command-processing device.

A content delivery network or data management network is a geographically distributed network of proxy servers and their data centers. The main goal is to provide high availability and performance by distributing services to consumers depending on territorial location.

A database is a structured system of data typically stored and accessible electronically through the use of a computer system.

PostgreSQL is a standard object-relational database management system, the most advanced open source system.

Payback period—the period of time required for the income generated by the investment to cover the cost of the investment.

NPV—Net Present Value, an indicator of efficiency estimation of the investment projects.

IRR is the interest rate at which the net present value is 0.

ROI—Return on Investment.

AI—When the AI abbreviation is used in this reference document, it refers to a broader topic, which includes artificial intelligence (AI), machine learning (ML) and deep learning (DL).

An internal unit of account is a type of digital currency, the creation and control of which is based on cryptographic methods.

A smart-contract is a computer algorithm designed to generate, control and provide information about the ownership of something.

Blockchain is a database that is a continuous chain of blocks and is stored simultaneously on many computers.

Transaction—a minimal logically reasonable operation that makes sense and can only be performed completely.

Clusters—a set of cloud resources required to run containers. It is associated with multiple server nodes, server load balancer instances, virtual private cloud (VPC), and other cloud resources.

A node is a server (a cloud-based web Elastic Cloud Server (ECS) or a physical server) in which the Docker Engine is installed and which is used to deploy and configure containers. The Agent program in the containerized service is installed in the node and registered in the cluster. The number of nodes in the cluster is scalable.

A container is a running instance created by using the Docker image. A single node can run many containers.

Image is a standard container application format in Docker. It is possible to tell the image to deploy containerized applications. The image can be taken from the Docker Hub, Alibaba or from your personal register. The image ID is determined by the image repository URL and the image tag (the latter is the default).

The functioning of the entire disclosure is organized by means of the associated components of the system 400, each of which performs its complete function, as shown in FIG. 4. Many components, logically sorted into groups, form the entire container and, accordingly, subcontainers, as shown in FIG. 2. Subcontainers can contain components similar in technological stack and semantic charge.

Access to the container is carried out according to the PaaS model, i.e., external services can use the components of the present disclosure according to the client-server model. Organizing the container using the PaaS model allows third-party access to components.

Applications with a full user interface can consist of one or more components, the exchange of messages with which is carried out through a single communication channel. In some embodiments, the communication channel is a gateway for system messages with the specified execution sequence and priority. Thus, the container organizes a shared pool of messages that are intended for a specific component of the system 400. Applications work asynchronously with responses from several components, which can cause the creation of a pool of answers that must be worked out on the interface.

Thereinunder follows the description of the method of data analysis and support of transactions in the global real estate market, depicted in the form of a flow chart in FIG. 7 and in the form of the system architecture in FIG. 8 by steps.

Step 710: receiving data on at least one user who buys or invests in the real estate unit and/or land plot and data on at least one user who sells or raises funds for at least one real estate unit and/or one land plot, as well as data on them.

Previously, in the present disclosure, data on users and data on a real estate unit or land plot are obtained.

In some embodiments, the above data about the real estate unit or land plot is obtained in the form of layers from open data sources represented as unstructured data, for example, from an external server or any other data warehouse that may be local or remote. After collection and processing, data is stored on the servers of the present system 400 and issued as requested. Layers are data types related to a land plot or a real estate unit that are divided into categories. The nature of the information of each layer cannot overlap with another due to the fact that each layer is formed as a logically complete slice of information about the territory; furthermore, the information that the layer displays should be unequivocal and useful. When divided into groups, layers may vary depending on the type of group.

For example, the “Natural Layers” group may include satellite landscape pictures, a climatic base map, lithospheric data, soil and ground data, geodetic data of the area, etc., without limitation.

The “General Filters” group may include the volume of investments, projected returns, projected risk, project type, project segment, regions, etc.

The “Natural Filters” group may include the total area, natural topography, water bodies, average monthly temperature, monthly rainfall, prevailing and dominant winds, seismic activity and the presence of force majeure factors, air pollution, soil type, the presence and type of groundwater, the presence of geodetic surveys, etc., without limitation.

The “Artificial Layers” group may include the type of permitted use of the land plot, the separation from the infrastructure center, prospects for the development of the city, the passability and passage, the availability of highways and pedestrian walkways, the availability of engineering communications, the capacity of existing communications, the permitted building height, the presence of the significant municipal objects in the surroundings, the presence of harmful objects in the surroundings, the presence of objects of the same segment in the city and their distance from the considered one, the presence of prospective service consumers, population changes, consumer purchasing power and preferences.

The “Artificial Filters” group may include an administrative-political map of the area, street and road networks, engineering communications, the master plan of the area, the cadastral map of the area, the location of commercial segments in the area and the economic characteristics of the population.

The “Special layers” group can include a detailed 3D map of a city (if it is provided by the city or by the GIS services, such as an online map).

As software from which information on objects by layers is received in a specific implementation of the proposed disclosure, it is also possible to use such software products as ArcView, Arc/Info, ESRL programs, MapInfo (MapInfo Corp.), MGE (Intergraph), GeoDraw/GeoGraph/GeoConstructor (CCI of the Institute of Geography, Russian Academy of Sciences, Moscow), Atlas GIS (Strategic Mapping Inc.), WinGIS/WinMAP (Progis), Geocad System 3 (Geocad. Ltd. Novosibirsk), Sinteks/Tri (Trisoft), or Panorama-97 (GeoSpectrum International, Moscow), without limitation.

Programs differ in their functionality and purpose. The choice of a particular program is determined by their main categories: tool GIS, viewers, specialized GIS, reference systems, vectorizers. At the same time, the solution for a specific task determines the necessary software, which is connected automatically.

Layers (coatings) can be represented as vector information, each containing a number of vector objects (usually points, lines and polygons). Spatial objects of the layer are chosen in accordance with attribute tables and databases. Many overlapping objects on the map are managed using frameworks that provide information about the visualization method. The display may vary depending on which layer the objects on the map belong to (linear objects—roads and rivers are displayed differently), or depending on the quantitative or qualitative parameter associated with the object itself. Internal characteristics contain information about what color and what placeholder polygons will be marked in different layers, what type of line linear objects will be drawn with, what icons point objects will be shown with, etc.

The initial position of the map displays the location of the object on the map. In some embodiments, ready-made public maps (for example, Google Maps Platform) and layers on them can be used, and it is also possible to create custom maps in order to close the display needs of certain non-standard infrastructure components.

The Google Maps Platform allows for the use of static and dynamic maps, street images and a 360-degree overview in the finished version; furthermore, the maps are stylized for the overall design of the project.

A virtual 3D tour is a “stitched” combination of panoramas with ability to switching from one volumetric photo to another. The main difference between a virtual tour and a set of ordinary photos is its interactivity: the user chooses which fragment is attractive at a given moment, what to zoom in and out on, and whether to scroll up or down. In other words, the user independently controls the picture, and is able to move and examine the details.

Data on a land plot (hereinafter sometimes “LP”) can contain without limitation a number in the system, owner information, activity status (not ready for transaction, neutral, ready for transaction), cadastral data, topographic images and coordinates, the category of a land plot, permitted use of the territory, current encumbrances, total area, living space.

These cards of the real estate unit can contain the number in the system, owner information, activity status (not ready for deal, neutral, ready for deal), cadastral data of the facility, topographic images and coordinates, building category and format, type of property rights, current encumbrances of the unit, total area, and commercial space.

The card of the object contains all the basic information about the object, which allows for making a decision to cooperate on this object.

The graphical user interface that displays the real estate unit in the system is divided into two workspaces:
technical information on the object;
visualization of the object and technical information.

Each object has additional functionality:
saving objects to one's personal list on the dashboard;
printing the object card.

The input data for building a financial model on a data-processing component or processor can be real estate unit data and/or land plot data.

The user may be the buyer of the property or the land plot, the property or land plot investor, the seller of the property or land plot, or the owner of the property or land plot.

Similarly, in the present disclosure, there are the following logical units of data:
real estate unit cards or LP that contain technical-economic indicators and documentation, as well as GIS data that can go into layers;
user cards, personal information about the user and the history of work in the present disclosure;
financial models calculated for a particular real estate unit or land plot;
Business Terms Sheet (BTS), which are the primary terms of interaction between the participants of the transaction, which will be disclosed in more detail below;
contract;
smart-contract.

At the first step of the present disclosure, after receiving the data about users, the identification and verification of users in the system 400 is carried out. In a user's personal account there is information about personal balance, as well as the total number of internal units of account of the present disclosure, their capitalization and price.

User verification involves the authentication of identity, residency and payment details using a group of procedures that comply with KYC and AML policies.

To access the service, users are divided into the following types:

PU—those with public access (Eng. Public);

PR—those with private access (Eng. Private);

PV—verified users that have full access (Eng. Verification).

Public access is distributed on the page:
Landing (public) page;
Registration page;
Login page;
Password reset page.

To switch from public to private status, the user must register. Private access allows for the use of a limited version of the present disclosure, in which the main functionality will be either limited in use or limited in the video Demo data and by the personal account.

The user profile contains the user's avatar and nickname, which is the name of the organization (if registered as a legal entity) or the name and surname combined in one line (if registered as an individual).

The nickname is abbreviated and ends with three dots “ . . . ” if it exceeds 12 characters. For example: ‘The Global J . . . ’. The profile is a separate page in each user's personal account.

To switch from private status to a verified one, a user must go through the verification of the entity/physical person and the bank account, after which the user will have access to the full functionality of the present disclosure.

Verification of financial assets involves the conversion of fiat funds that were previously deposited by the user to his/her current account in the system 400, to the internal unit of account (for example, money) for the present disclosure.

To calculate the value of the internal money unit of account or the value of standard units of the monetary system in fiat monetary units (e.g., US dollars, Euros, Rubles etc.) or in monetary units of cryptocurrency (bitcoins, esters etc.), the system 400 can use the relevant exchange rate quotations, which the system may obtain as a result of trading in money/fiat currency pairs on monetary markets and stock exchanges.

After verification, for example, of a Bank account, the conversion to an internal unit of account becomes available. This unit of account allows for carrying out all operations within the present disclosure. Without the necessary amount to complete the transaction on the object, the buyer cannot complete the documentary registration of the transaction and draw up a smart-contract, which will be disclosed below. The conversion is performed using an external resource designed for this purpose. In some embodiments, the conversion is carried out through the reservation of funds in a special bank account. Having received confirmation in automatic mode, the corresponding number of internal units of account at the current exchange rate is issued in the present disclosure.

Verification of the bank account and payment is carried out as follows. Using the API provided by the bank, the present disclosure requests the balance, determines the currencies to be converted and fixes the balance for the account in the internal units of account of the present disclosure, creating a transaction in favor of the user. In some embodiments, a bank letter of credit may be used for the transaction.

In some embodiments, all transactions related to the conversion of internal units of account and to the transfer to service participants are recorded.

Verification of real estate assets can be done in several ways.

For example, it can be implemented as automatic confirmation in an external register, but only for registers integrated with the present disclosure. Automatic confirmation of ownership in the external register can be implemented by means of the application programming interface (API). Additionally, verification of the event by means of consensus in the blockchain can be implemented. As a consensus algorithm, Practical Byzantine Fault Tolerant (abbr. PBFT) can be used without limitation. The process of creating each block consists of several steps, at each of which the validators should evaluate the proposed block—whether to reject it as a Byzantine fault or accept it. Such a mechanism makes it possible to ensure the functioning of the network in the presence of no more than ⅓ of the Byzantine validators.

Automated confirmation in an external register can also be implemented for registers that have a public online version, but without the possibility of integration.

In some embodiments, for the registers that do not have a public online version, manual confirmation in an external register is possible.

User identification involves adding the necessary information about oneself, as well as determining his/her role in the system, which can be:
seller/owner/seller's representative/owner's representative;
buyer/investor/buyer's representative/investor's representative.

Identification of real estate assets is performed by adding the necessary information about the asset, as well as indicating the current status:
ready for transaction;
not ready for transaction (just observe);
closed to offers.

Next, a financial model is formed and built.

In the specific embodiment, financial assets do not need to be identified, but in other embodiments, it may be provided.

The financial assets of this user are then converted into an internal unit of account implemented in the present disclosure.

Furthermore, the filters are specified, after which the user can select a specific real estate unit or land plot, and view its data in the system. Filters can be divided into groups, e.g., geographical (country, city), economic (investment volume, rate of return), technical, according to the project stage, etc.

The filter applies the parameters on the map automatically. When filtering objects, the parameters specified in the filter can be displayed in the URL, for example: https://realty.nova.lc/research?=, as shown in FIG. 3.

After that, the user selects the type of use of the real estate unit or land plot.

Step 720: at least one financial model is created that represents the description of at least one real estate unit and/or a land plot and its development expressed in monetary terms based on the previously obtained data about it for the user who buys or invests in a real estate unit and/or a land plot.

Next, a financial model is formed.

The financial model is a description of the object and its development in monetary terms. The model reflects the relationships that are present in both financial flows and processes.

It contains the calculation of necessary financial indicators of the enterprise or the project, such as payback period, calculation of necessary investments, NPV, IRR, ROI, and Implementation period etc.

The present disclosure provides for editing the existing calculation parameters, adding new indicators, inputting the data about the object/infrastructure of the object by the user, and adding new indicators of the object/infrastructure of the object to display by the service.

For this purpose, each indicator has:
Symbol for internal calculations;
Symbol for displaying data to users in the public part of the project;
Indicator status (checkbox: input data or function output);
Default values (for input data, without further calculation conditions);
Input field for the calculation function (the input field allows for entering data on the calculation function of the indicator in ordinary mathematical values using the symbolic values of the indicators for internal calculations).

Initially, the values of the payback period and the calculation of the necessary investments can be changed for detailed analysis. By default, these values are set to optimal for maximum benefit.

In some embodiments, the financial model is public to all PV type (verified user) users. The construction of the financial model involves validated data that is input by the seller of the object, data obtained from the external open sources, and data related to the state of the project.

For ease of displaying them to the user, the diagrams displaying the following indicators are formed, as shown in FIG. 5:
Internal Rate of Return|IRR%
NCF Sensitivity Model

Each user can build an individual financial model for the selected unit in the system.

Each financial model can be added to favorites and then it will be displayed in a special section—“Modeling”. This is an individual section in which all the financial models of different units are built for quick access to them.

An additional functionality for the financial model is the ability to download it in PDF format, implemented by means of the pdf-lib, which fills out the data in the preset template.

All prices are displayed in a user-friendly currency. Currency conversion is performed taking into account current data on currency prices and is fixed at the moment the transaction is completed.

For each unit, a financial model is built with respect to a certain type of use.

In the case where the user is the owner of a real estate unit or land plot, he/she undergoes additional verification of the real estate unit or land plot.

Step 730: at least one session of parties to a transaction is created via the messenger, which joins at least one user who has selected at least one specific real estate unit and/or a land plot and at least one user who is the owner of at least one selected real estate unit and/or one land plot.

Furthermore, a session of participants through the transaction messenger is formed where only identified and verified participants who received the invitation may be present.

In some embodiments without limitation, the messenger can be implemented as a service application that users need to discuss the conditions of a future transaction prior to initiating it in the following component.

Messenger is a component for interacting with other users on the service that allows for the exchange of messages, photos and documents with other users. For online chats and channels, the backend and web app uses WebSocket connection and pre-assembled libraries for interaction.

In some embodiments, the messenger has two types of interface:
full-fledged, having a dedicated page to communicate with users.
simplified, representing an element for quick access to sending messages about the particular object.

If there are messages for the user that have not been considered, a notification about unread messages is received.

Microservice application architecture allows users to combine several such applications in a multi-user channel for simultaneous access, with the ability to switch the application interface to chat mode, as well as create, along with web applications, native applications for different environments and channels. The proposed solution implements the unification of all available communication channels around the user when he consults.

This chat and/or messenger and/or messages module and/or calls module allows users to exchange personal messages and/or create group chats and join existing chats, depending on their interests, preferences, rating values and/or thematic rating. These messages may contain at least the following types of data: text, graphics, video, audio, etc.

Through the messages module and/or the calls module, the user has the opportunity to use the full functionality of the messenger: the ability to organize personal and secretive correspondence, chats, calls and/or the possibility of group chats and/or audio and/or video calls and/or conferences, which are organized on any topics of interest to a particular user. Moreover, when organizing the above chats between users in the system, it is possible to evaluate users through the unique automated system of intelligent rating calculation. This system further increases the reliability of all chats between users about a particular topic.

A user, who has chosen a suitable real estate unit or land plot, checks the status of the object (for example, ready or not ready for transaction) and can contact its owner via messenger.

Step 740: Form at least one BTS (Business Term Sheet) document in the messenger.

During negotiations, it is possible to fix the initial conditions (for example, on the standard form of BTS). Communication in the messenger is linked to the real estate unit and exists until the completion of the transaction. Also, the BTS is formed in this session.

The discussion of the transaction terms can begin with at least two participants, but it is then possible to add more participants if required. Added participants can see the entire history of the correspondence.

The agreements reached in the course of discussion may be recorded in the standard BTS form, and then on the basis of this form, a contract can be drawn up and, accordingly, terms and conditions are automatically added to the smart-contract, if it is formalizable. After it is created, users have the right to correct legal wording and secondary conditions. The present disclosure has a built-in translator for several languages, for example, through integration with Google.Translate. The Cloud Translation API framework can also be used, which can quickly translate text in thousands of language pairs. The Cloud Translation API allows websites and programs to communicate with the translation service programmatically. Cloud Translation is part of a broader line of Cloud Machine Learning API.

Also, the present disclosure provides dynamic text translation using pre-trained user models of Google machine learning.

Based on the terminology and requirements of the service users within the framework of using the Google Translate API, the structure of AutoML Translation will be built.

After linguistic analysis, the conceptual framework of language pairs will be introduced. The AutoML Translation technology will prepare the final model of dynamic translation based on the previously obtained neural machine translation data, as the result will be the use of one library for translation by means of Google Translate API.

After the first user searching for a real estate unit or a land plot finds the owner of this real estate unit and agrees with him about the start of the discussion of the details of the transaction concerning the real estate unit, the component is launched (which represents the messenger), allowing all participants to interact and manage all processes associated with the transaction. The functionality of the component includes the framework for creating smart-contracts based on the compiled transaction logic and convenient tools for the creation and coordination of contracts, as well as secure document and asset storage.

Step 750: conclude a transaction contract, and then conclude a smart-contract based on the BTS and transaction contract, according to transaction instructions received from the users.

To begin the transaction, it is necessary to coordinate three important stages with an electronic signature:
BTS—Business Term Sheet (agreement on the main transaction terms and conditions, Declaration of Intent);
Contract;
Smart-contract.

The BTS agreement should receive bilateral approval, after which the filling out and signing of the contract and the creation of a smart-contract will be available in the terminal.

On the basis of the BTS form filled out in the messenger, it is possible to manually or automatically select “anchor conditions” (e.g., contract form, price, payment method, transaction currencies, contract languages) and contract parties with details that are added to the smart-contract of the transaction.

On the basis of the selected contract forms in the agreed BTS, transactions become available to the participants of the transaction. The contract may be prepared in one or more languages.

The contract is filled out by the participants conjointly. After filling out the contract, each of the parties should sign it with an electronic digital signature. For the purpose of finalizing the physical transaction, it is necessary to use the certifying mechanism for document management. To determine the authorship and the document invariability during the transaction, an electronic digital signature is used. The mechanism used to create an electronic digital signature is encryption (cryptoconversion) by a cloud service algorithm on a specific key. The verification of the signature, in this case, represents its recalculation and comparison with the one available on the side of the reviewer, as shown in FIG. 6.

Frozen tranches are transferred to the executive in accordance with the terms of the contract and smart-contract. The transfer of funds is possible only if all parties of the transaction accept the works and terms. The tranche freeze refers to depositing funds in a smart-contract until a predetermined event occurs, which can be confirmed in the smart-contract, at which point the funds are “free”.

In the present disclosure, standard blocks of contracts are prepared in several languages; these blocks may be used by users, wishing to make a transaction, to prepare the most relevant contract acceptable by all the parties of the transaction.

Each contract block may have formalizable terms and conditions that are automatically mirrored into the program code. Users can define exactly which terms and conditions they wish to stipulate within the smart-contract, as well as add their own terms and conditions. In some embodiments, smart-contracts may be Exonum-derived, which represent business, which may instantly add blockchain. Exonum-derived smart-contracts also have the highest performance in terms of transaction processing, as they are capable of processing up to 5,000 transactions per second with a clear time of 0.5 seconds and up to 15,000 transactions per second in user-defined situations.

Exonum represents a permissioned blockchain. This means that blockchain members can be identified; moreover, separate blockchain members may receive a different set of permissions. In practice, this means that certain nodes of blockchain are authorized to participate in decision-making (consensus), while the rest of the nodes are simple observers. Compared to the scope of bitcoin, where there is no credibility factor between anonymous members, the Exonum environment presupposes a partial credibility environment. This is due to the specific features of applications in the Exonum environment.

Blockchain may represent both a register of operations of the whole system, and a register of operations of a particular wallet or group of wallets. The mechanism for reaching a consensus and securing transactions in the payment system may be implemented by any known method or by a new method. A new Proof-Of-Value (POV) mechanism is the preferred method for reaching a consensus, as noted above.

Since the system is not aimed at the value of internal monetary units of account (tokens) and maintaining their stable value, the concept of the time value of money in relation to the value of tokens also loses its significance. In the standard system, one can talk about only the time value of the cost standard and its change in some cases. However, in the standard system, it is possible to implement loans and interest payments on loans, and it is also possible to implement the withdrawal of part of the cash liquidity in an amount equivalent to a negative rate, which allows, for example, the withholding of taxes.

Since the environment is primarily used in a corporate/government environment where blockchain nodes are pre-approved and can be identified, there may be a certain confidence level. Regardless, Exonum takes into account the fact that the node may misbehave or may be compromised and thus could be used with malicious intent.

According to their specifications, Exonum-based systems can withstand only up to 13 malfunctioning nodes among the total number of nodes in the system, and under such conditions can still reach a consensus.

Smart-contracts may be implemented in Rust language and embedded directly into the code of blockchain nodes. This design provides memory security and ensures that smart-contracts are speed-optimized.

Cash transactions can work in Node.js with the Exonum client library used to sign transactions before sending these transactions to blockchain and to verify blockchain responses by means of cryptographic proof.

As described in the present disclosure, a “transaction reviewer” or a “reviewer” means the party whose efforts and resources are used to verify the terms of the transaction after acceptance of those terms. An automated infrastructure, which includes a set of interoperable software and hardware described below, serves as the transaction verification tool.

In particular, the following parties may act as the effectors of a transaction: a bank or a payment system (if a transaction results in a transfer between accounts), a broker (if a transaction results in a purchase or sale of securities or real estate), WEB or WAPresource (if a transaction results in authorization on WEB or WAP resource and/or access to informational content of WEB or WAPresource), a physical person or a legal entity (if a transaction results in endorsing the document or enabling the use of an encrypted file or property, such as a personal computer or DVD), without limitation.

The component is operated via graphical user interface; the logical units are added by the project team as the platform is developed.

Maintaining the initial terms is provided by the blockchain decentralized distributed ledger technology. The permissioned blockchain may be used, for example, with BTF consensus, the nodes of which must be available to all parties to the transaction, as well as other market participants that support the platform.

In some embodiments, the alternative to the blockchain would be the arrangement of a standard infrastructure for payment processing. However, in this case, it is quite difficult to ensure full compliance with the terms, although in a version with blockchain this will be held up for the number of nodes (net members) that support the platform.

Step 750a: if the terms of the smart-contract are accepted, the monetary funds from at least one user who buys or invests in at least one real estate unit and/or land plot are transferred to at least one other user who sells or raises funds for at least one real estate unit and/or land plot.

Examples of acceptance of compliance with the terms in simple transactions:

Blockchain register—automated request to other register, information acquisition, acceptance.

Other technology register—monetary funds are transferred to an escrow account inaccessible to anyone, the user manually transfers the property title, the information is entered into the system, and the monetary funds are transferred to the payee (recipient). If no request is present, then the monetary funds are returned to the remitter.

In some embodiments, the present disclosure may contain a personal voice assistant for a user, which helps to understand the interface and provides advice throughout the transaction on the object. Personal voice assistant is available on all pages of the service and has two options for interaction:
voice control—activated by default;
control via a dialog box.

The voice assistant may be implemented in Python programming language and Flask web framework designed on the basis of answer-generation using Tensorflow.

In the present disclosure, the dialog agents or chat bots (chat robots) may be used. Three types are available: the first type operates on the basis of predetermined rules, the second one operates on the basis of information search, and the third one combines both the first and second types. They differ in the freedom they have when generating answers to a question. Chat-bot models used in public services belong to the first or the second type, taking into account the requirement to ensure quality and adequate answers to users.

However, these models can keep up only those conversations that match with their previously recorded answers, so the conversations may sound absurd and incoherent if they go beyond the topic.

Generative models support the conversations better, which makes them a more common type. Hybrid models can be used by applying neural machine translation technologies to a cyclic encoding/decoding architecture.

A dialogue agent or a chat-bot is a language recognition system configured to keep up a conversation with a user by means of a question-and-answer protocol. The conversation may be handled in audio or text format.

All the components of the system 400 listed above can be interconnected via a telecommunication channel or a data link.

As used herein, a “telecommunication channel” or a “data link” means an electronic (i.e., by means of electrical or radio signals) data transmission facility with at least two ends adapted for data communication between the connected nodes. The telecommunication channel has a predetermined structure and electrical signal specifications and operates in accordance with one of the physical layer protocols, i.e., the 1-layer protocol according to the 7-layer ISO/OSI model. Data in a telecommunication channel is transported using the known data link layer, network layer, transport layer, session layer, presentation layer and application layer protocols in the 7-layer ISO/OSI model (see, for example, ISO/IEC 7498-1: 1994 and ITU-T Recommendation X. 200, 1994).

Telephone networks or telecommunication channels operating in accordance with other protocols of the data link layer, network layer, transport layer, session layer, presentation layer and/or application layer, or the elements of nodes in accordance with the methods and devices pursuant to the present disclosure, may serve as data transmission nodes.

In one of the embodiments, the telecommunication channel uses the physical layer protocol chosen from the group consisting of V.92 (see ITU-T V.92), IRDA, USB, Firewire, EIA RS-232, EIA-422, EIA-423, RS-449, RS-485, DSL, ISDN, Ethernet (see IEEE 802.3 standards), SONET/SDH, GSM radio interface, Bluetooth, IEEE 802.1x Wi-Fi, Etherloop, MTP-1 (Message Transport Protocol), MTP-2, and MTP-3.

Preferably, the telecommunication channel uses the transport layer protocol chosen from the group consisting of Ethernet and ISDN.

In one of the embodiments, the telecommunication channel uses the transport layer protocol chosen from the group consisting of AEP (AppleTalk Echo Protocol), ATP (AppleTalk Transaction Protocol), CUDP (Cyclic UDP), DCCP (Datagram Congestion Control Protocol), FCIP (Fiber Channel over TCP/IP), FCP (Fiber Channel Protocol), IL (IL Protocol), iSCSI (Internet Small Computer System Interface), LCP (B PPP, Link Control Protocol), NBF (NetBIOS Frames protocol), NBP (Name Binding Protocol), RTMP (Routing Table Maintenance Protocol), SCSI (Small Computer System Interface), SCTP (Stream Control Transmission Protocol), SPX (Sequenced Packet Exchange), SST (Structured Stream Transport), TCP (Transmission Control Protocol), UDP (User Datagram Protocol), UDP Lite, SCTP (Stream Control Transmission Protocol), and RSVP (Resource ReSerVation Protocol).

Preferably, the telecommunication channel uses the transport layer protocol chosen from the group consisting of TCP and UDP.

In one of the embodiments, the telecommunication channel uses the data link layer protocol chosen from the group consisting of ATM (Asynchronous Transfer Mode), PPP (Point-to-Point Protocol, see, for example, IETF RFC 1661).

In one of the embodiments, the telecommunication channel uses the network layer protocol chosen from the group consisting of X.25 (See, for example, ITU-T Recommendation X.25).

In one of the embodiments, the telecommunication channel uses the telecommunication protocol chosen from the group consisting of SS/7 (Signaling System #7, see, for example, ITU-T Recommendation Q.700) and ISDN (Integrated Services Digital Network), and WiFi (see, for example, IEEE Standard 802.11).

In one of the embodiments, the telecommunication channel uses TCP/IP (Transmission Control Protocol/Internet Protocol, see IETF RFC 1122).

With reference to FIG. 4, the present disclosure can be implemented as a computing system 400 of data analysis and support of transactions in the global real estate market, which includes one or more of the following components:

a processing component 401 containing at least one processor 402,

a memory 403,

a multimedia component 405,

an audio component 406,

an input/output interface (I/O) 407,

a sensory component 408,

a data transmission component 409.

The processing component 401 primarily controls all operations of the system 400, for example, processes data on real estate units, as well as controls the display, phone calls, data transmission, camera operation and recording operations of a subject's mobile communication device. The processing component 401 may include one or more processors 402 executing commands for the completion of all or some of the stages from the above-mentioned methods. Moreover, the processing component 401 may include one or more modules for convenient interaction between other processing components 401 and other modules. For example, the processing component 401 may include a multimedia module for convenient easier interaction between the multimedia component 405 and the processing component 401.

The memory 403 is configured to store various types of data to support the operation of the system 400, such as a database with user profiles. Examples of such data include commands from any application or method, contact details, address book data, messages, images, videos, etc., and they all work on the system 400. The memory 403 can be implemented in the form of any type of volatile memory, non-volatile memory or a combination thereof, including but not limited to static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk, optical disk, etc.

The multimedia component 405 includes a screen providing an output interface between the user and the system 400, which can be installed on the user's mobile communication device. In some embodiments, the screen can be a liquid crystal display (LCD) or a touch panel (TP). If the screen includes a touch panel, the screen can be implemented as a touch screen to receive input from the subject. The touch panel includes one or more touch sensors detecting gestures, touching and sliding of the touch panel. The sensor can sense touching borders or flick gestures of the subject, and can determine the duration of time and pressure associated with the touching and sliding modes. In some embodiments, the multimedia component 405 includes one front-facing camera and/or one rear-facing camera. When the system 400 is in an operating mode, for example, in a photo mode or a video mode, the front-facing camera and/or the rear-facing camera can receive multimedia data externally. Each front-facing camera and rear-facing camera can be one fixed lens optical system or have a focal distance or an optical zoom.

The audio component 406 is configured to output and/or input audio signals. For example, the audio component 406 includes one microphone (MIC) that is configured to receive external audio signals when the system 400 is in an operating mode, for example, in a call mode, a record mode or a voice recognition mode. The audio signal received can further be stored in the memory 403 or can be sent to the data transmission component 409. In some embodiments, the audio component 406 also includes one loudspeaker configured to output audio signals.

The input/output interface (I/O) 407 provides an interface between the processing component 401 and any peripheral interface module. The above-mentioned peripheral interface module can be a keyboard, a steering wheel, a button, etc. These buttons may include a start button, a volume button, an initiate button and a lock button, but this list is non-exhaustive.

The sensory component 408 contains one or more sensors and is configured to provide various aspects of condition assessment of the system 400. For example, the sensory component 408 can detect on/off conditions of the system 400, the relative position of its components, such as the display and the keypad, a single component of the system 400, the presence or absence of contact between the user and the system 400, as well as the orientation or acceleration/deceleration and temperature change of the system 400. The sensory component 408 contains a non-contact sensor configured to detect the presence of an object nearby when there is no physical contact. The sensory component 408 may include an optical sensor (for example, a CMOS or a CCD image sensor) configured to be used in the visualization of the application. In some embodiments, the sensory component 408 contains an acceleration sensor, a gyro sensor, a magnetic sensor, a pressure sensor or a temperature sensor.

The data transmission component 409 is configured to facilitate wired or wireless communication between the system 400 and other devices. The system 400 can access a wireless network based on communication standards, such as Wi-Fi, 2G, 3G, 5G or combinations thereof. In an exemplary embodiment, the data transmission component 409 receives a broadcast signal or a translation, information related to them from an external broadcast control system through a broadcast channel. In one embodiment, the data transmission component 409 may include a near field communication (NFC) module to facilitate near field communication. For example, the NFC module can be based on radio frequency identification (RFID) technology, infrared data association (IrDA) technology, ultra-wideband (UWB) technology, Bluetooth (BT) technology, etc.

In an exemplary embodiment, the system 400 can be implemented by means of one or more application-specific integrated circuits (ASIC), a digital signal processor (DSP), digital signal processing devices (DSPDs), a programmable logic device (PLD), a field-programmed gate array (FPGA), a controller, a microcontroller, a microprocessor or other electronic components and can be configured to implement the method 500 of real estate transaction support.

In an exemplary embodiment, a non-volatile computer-readable medium may include the memory 403 that contains commands, where these commands are executed by the processor 401 of the system 400 for implementing the above methods of real estate transaction support. For example, the non-volatile computer-readable medium can be read-only memory (ROM), random-access memory (RAM), a compact disk, a magnetic tape, floppy disks, optical storage devices, etc.

The computing system 400 may include a display interface that transmits graphics, text and other data from the communication infrastructure (or from a frame buffer, not shown) to display on the multimedia component 405. The computing system 400 additionally includes input devices or peripheral devices. The peripheral devices may include one or more devices to interact with the subject's mobile communication device, such as a keyboard, a microphone, a wearable device, a camera, one or more audio speakers, and other sensors. The peripheral devices can be external or internal to the subject's mobile communication device. The touchscreen can usually display graphics and text and also provides a user interface (for example, a graphical user interface (GUI)) through which the user can interact with the user's mobile communication device, such as accessing and interacting with applications running on this device.

The elements of the claimed disclosure are in functional interrelationships, and their multiple uses lead to the creation of a new and unique disclosure. Thus, all the units are functionally related.

All the units used in the system can be implemented using electronic components used to create digital integrated circuits, which is obvious for a person skilled in the art. Chips, the logic of which is specified during manufacturing, or field-programmable gate arrays (FPGAs), the logic of which is specified by programming, can also be used without limitation. For programming, programmers and debugging environments are used that allow for setting the desired structure of a digital device in the form of an electrical schematic diagram or a program in special hardware description languages: Verilog, VHDL, AHDL and others. An alternative to FPGAs can be programmable logic controllers (PLC), master slice arrays (MSA), which require a factory production process for programming, ASIC, i.e., application-specific custom-designed large-scale integrated circuits (LSIC), which are much more expensive for small-batch and individual production.

Usually, an FPGA chip itself consists of the following components:
configurable logic units that implement the required logical function;
programmable electronic connections between configurable logic units;
programmable input/output units that provide communication between the external output of the chip and the internal logic.

The units can also be implemented using read-only memory.

Thus, implementation of all used units is achieved by standard means based on the classical principles of implementing the fundamentals of computer engineering.

As will be understood by a person skilled in the art, the aspects of the present disclosure can be implemented in the form of a system, a method, or a computer program product. Accordingly, various aspects of the present disclosure can be implemented solely as hardware, as software (including application software, etc.) or as an embodiment combining software and hardware aspects, which in general may be referred to as “the module”, “the system” or “the architecture”. Moreover, aspects of the present disclosure can take the form of a computer program product implemented on one or more computer-readable media with a computer-readable program code implemented on them.

Any combination of one or more machine-readable media can also be used. A machine-readable storage medium can be, without limitation, an electronic, magnetic, optical, electromagnetic, infrared or semiconductor system, a device, an apparatus or any suitable combination thereof. More specifically, examples (non-exhaustive list) of machine-readable storage media include: an electrical connection using one or more wires, a portable computer floppy disk, a hard disk, random-access memory (RAM), read-only memory (ROM), erasable programmable read-only memory (EPROM or flash memory), a fiber optic connection, compact disc read-only memory (CD-ROM), an optical storage device, a magnetic storage device or any combination thereof. In the context of this description, a machine-readable storage medium can be any flexible data medium that can contain or store a program for use by the system, device, apparatus, or in conjunction therewith.

The program code embedded in the machine-readable medium can be transmitted by any medium, including, without limitation, wireless, wired, fiber optic, infrared and any other suitable network or a combination thereof.

The computer program code for performing operations for the stages of the present disclosure can be written in any programming language or a combination of programming languages, including object-oriented programming languages, such as Python, R, Java, Smalltalk, C++, etc., and conventional procedural programming languages, such as the programming language “C” or similar programming languages. The program code can be executed on the subject's computer in full, in part, or as a separate software package, partly on the subject's computer and partly on the remote computer, or completely on the remote computer. In the latter case, the remote computer can be connected to the user's computer via any type of network, including a local area network (LAN), a wide area network (WAN) or a connection to an external computer (for example, over the Internet using Internet service providers).

The aspects of the present disclosure have been closely described with reference to flow charts, circuit diagrams and/or diagrams of methods, devices (systems) and computer program products in accordance with embodiments of the present disclosure. It should be noted that each component of the flow chart and/or diagrams, as well as combinations of components of the flow chart and/or diagrams, can be implemented with computer program commands. These computer program commands can be provided to a general-purpose computer processor, a special-purpose computer processor, or another data-processing device to create a procedure in such a way that the commands executed by the computer processor or other programmable data-processing device create the means for implementing the functions/actions specified in a component or components of the flow chart and/or the diagram.

These computer program commands can also be stored on a machine-readable medium, that can control a computer other than a programmable data-processing device or other than devices that operate in a specific manner, in such a way that the commands stored on the machine-readable medium create a device, including commands that perform the functions/actions specified in a component of the flow chart and/or the diagram.

1. A method of data analysis and support of transactions in the global real estate market, performed by means of at least one processor and which includes the following steps:
receiving data on at least one user who buys or invests in at least one real estate unit and/or one land plot, and data on at least one user who sells or raises funds for at least one real estate unit and/or one land plot, as well as data on them;
creating at least one financial model that represents the description of at least one real estate unit and/or a land plot and its development expressed in monetary terms based on the previously obtained data about it for the user who buys or invests in a real estate unit and/or a land plot;
creating at least one session of parties to a transaction via the messenger, which joins at least one user who has selected at least one specific real estate unit and/or a land plot on the basis of financial model with at least one user who is the owner of at least one selected real estate unit and/or land plot,
forming at least one BTS (Business Term Sheet) document in the messenger;
concluding a transaction contract, and then concluding a smart-contract based on the BTS and transaction contract according to transaction instructions received from the users, and
a. if the terms of the smart-contract are accepted, the monetary funds from at least one user who buys or invests in at least one real estate unit and/or land plot are transferred to at least one other user who sells or raises funds for at least one real estate unit and/or land plot.

2. The method of claim 1, wherein the user is identified and verified after obtaining the data about him.

3. The method of claim 1, wherein the data about the real estate unit and/or land plot are obtained in terms of data provided by the owner of the real estate unit and/or land plot and in terms of layers from open data sources represented by unstructured data and correlation of all the obtained data.

4. The method of claim 2, wherein the verification includes authentication of identity, residence and banking details by going through a series of procedures in compliance with KYC and AML policy.

5. The method of claim 1, wherein after filling in the contract, each party signs it with an electronic digital signature.

6. The method of claim 1, wherein the transaction contract is prepared from the set of predetermined blocks in single or several languages.

7. The method of claim 1, wherein the space planning design contains the computations on the analysis of the best and most effective usage of the real estate unit and/or land plot.

8. The method of claim 1, wherein the financial model includes the calculation of financial indicators, such as the payback period and/or calculation of the necessary investments, and/or NPV, and/or IRR, and/or ROI, and/or Implementation period.

9. The method of claim 1, wherein the terms of the smart-contract are recorded in the distributed ledger with a blockchain data storage structure.

10. The method of claim 1, wherein after the data about the real estate unit and/or the land plot are received, they undergo verification.

11. The method of claim 1, wherein the messenger is implemented as a service application, which is necessary for users to discuss the conditions of the upcoming transaction prior to its commencement.

12. A computing system for data analysis and support of transactions in the global real estate market containing:
at least one processor;
at least one system memory;
at least one computer-readable storage medium with the pre-recorded computer-executable commands that, when executed by one or more processors, instruct the computing system to perform the method of claim 1.
